(19) United States
(12) Patent Application Publication
(10) Pub. No.: US 2008/0315042 A1
(43) Pub. Date: Dec. 25, 2008

(54) THRUST GENERATOR FOR A PROPULSION SYSTEM

(75) Inventors: Andrei Tristan Evulet, Clifton Park, NY (US); Ludwig Christian Haber, Rensselaer, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/765,666

(22) Filed: Jun. 20, 2007

(51) Int. Cl. F02C 3/32; F02C 3/00; B64D 33/02

(52) U.S. Cl. 244/53 B; 60/801

(57) ABSTRACT

A thrust generator is provided. The thrust generator includes an air inlet configured to introduce air within the thrust generator and a plenum configured to receive exhaust gas from a gas generator and to provide the exhaust gas over a Coanda profile, wherein the Coanda profile is configured to facilitate attachment of the exhaust gas to the profile to form a boundary layer and to entrain incoming air from the air inlet to generate thrust.

### BACKGROUND

The invention relates generally to propulsion systems, and more particularly, to a thrust generator for enhancing efficiency of a propulsion system.

Various propulsion systems are known and are in use. For example, in a jet aircraft powered by a turbojet engine, air enters an intake before being compressed to a higher pressure by a rotating compressor. The compressed air is passed on to a combustor where it is mixed with a fuel and ignited. The hot combustion gases then enter a turbine, where power is extracted to drive the compressor. In a turbojet, the exhaust gases from the turbine are accelerated through a nozzle to provide thrust.

Further, the exhaust gas flow is expanded to atmospheric pressure through the propelling nozzle that produces a net thrust to drive the jet aircraft. Typically, in a turbojet engine, the propelling nozzle is close to choked. Thus, the propulsion efficiency of such engines is limited since the only way to increase the thrust is to increase thermodynamic availability of the exhaust gas stream.

Certain other propulsion systems employ a turbofan engine. Typically, turbofan engines include the basic core of the turbojet along with additional turbine stages that are employed to extract power from the exhaust gases to drive a large fan, which accelerates and pressurizes ambient air and accelerates it through its own nozzle. The compressor, combustor and high pressure turbine within a turbofan engine are identical to that employed in a turbojet engine and are commonly referred to as the engine core or the gas generator. However, such systems require moving parts such as a fan, and a second shaft driven by the low pressure turbine. Due to certain practical limitations on parameters such as nacelle size and fan size, these devices have limited propulsion efficiency and are susceptible to engine damage due to foreign object debris (FOD).

Accordingly, there is a need for a propulsion system that has high propulsion efficiency and low specific fuel consumption. Furthermore, it would be desirable to provide a device that can be integrated with existing propulsion systems for enhancing the propulsion efficiency of such systems.

### BRIEF DESCRIPTION

Briefly, according to one embodiment a thrust generator is provided. The thrust generator includes an air inlet configured to introduce air within the thrust generator and a plenum configured to receive exhaust gas from a gas generator and to provide the exhaust gas over a Coanda profile, wherein the Coanda profile is configured to facilitate attachment of the exhaust gas to the profile to form a boundary layer and to entrain incoming air from the air inlet to generate thrust.

In another embodiment, an aircraft is provided. The aircraft includes an aircraft frame and a gas generator coupled to the aircraft frame and configured to generate exhaust gas. The aircraft also includes a plurality of thrust generators coupled to the aircraft frame and configured to receive the exhaust gas from the gas generator and to generate thrust for driving the aircraft, wherein each of the plurality of thrust generators comprises at least one surface of the thrust generator having a Coanda profile configured to facilitate attachment of the exhaust gas to the profile to form a boundary layer and to entrain incoming air from an air inlet to generate the high flow rate and velocity airflow.

In another embodiment, a method for generating thrust is provided. The method includes introducing exhaust gas from a gas generator over a Coanda profile of a thrust generator to form a boundary layer and entraining air through the boundary layer to generate thrust from a difference in momentum between inlet and exhaust fluxes of airflow.

In another embodiment, a method of enhancing a propulsion efficiency of an aircraft is provided. The method includes coupling at least one thrust generator to a gas generator of the aircraft, wherein the at least one thrust generator is configured to generate thrust by diverting exhaust gas from the gas generator over a Coanda profile to form a boundary layer and subsequently entrain incoming air through the boundary layer.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical illustration of an aircraft having a plurality of thrust generators in accordance with aspects of the present technique.

FIG. 2 is a diagrammatical illustration of an exemplary configuration of gas generator of the aircraft of FIG. 1 in accordance with aspects of the present technique.

FIG. 3 is a diagrammatical illustration of exhaust gas flow split from the gas generator of FIG. 2 in accordance with aspects of the present technique.

FIG. 4 is a diagrammatical illustration of an attachment mechanism of the gas generator with the aircraft of FIG. 1 in accordance with aspects of the present technique.

FIG. 5 is a diagrammatical illustration of an exemplary configuration of the thrust generator of FIG. 1 in accordance with aspects of the present technique.

FIG. 6 is a block diagram illustrating the operation of the thrust generator of FIG. 5 in accordance with aspects of the present technique.

FIG. 7 is a diagrammatical illustration of a Coanda profile surface of the thrust generator of FIG. 5 in accordance with aspects of the present technique.

FIG. 8 is a diagrammatical illustration of flow profiles of air and exhaust gases within the thrust generator of FIG. 5 in accordance with aspects of the present technique.

FIG. 9 is a diagrammatical illustration of the formation of boundary layer adjacent a Coanda profile in the thrust generator of FIG. 5 in accordance with aspects of the present technique.

FIG. 10 is a graphical representation of exemplary analysis results for propulsion efficiency of existing propulsion systems and a propulsion system having the thrust generator of FIG. 5 in accordance with aspects of the present technique.

FIG. 11 is a graphical representation of exemplary analysis results for thrust generated from existing propulsion systems and a propulsion system having the thrust generator of FIG. 5 in accordance with aspects of the present technique.

FIG. 12 illustrates an exemplary aircraft having thrust generators positioned at ends of the wings of the aircraft in accordance with aspects of the present technique.

### DETAILED DESCRIPTION

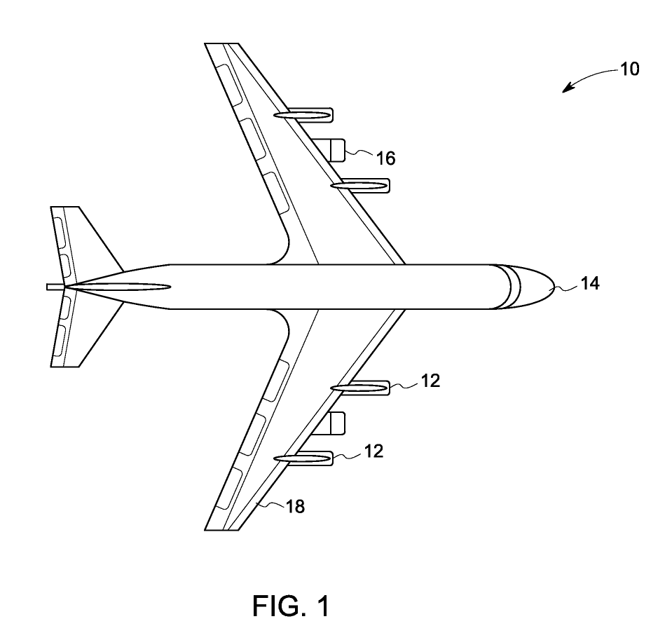

As discussed in detail below, embodiments of the present technique function to enhance efficiency of propulsion systems such as a jet aircraft powered by a turbojet engine. In particular, the present technique utilizes the combination of a working fluid and ambient air to generate thrust for driving the propulsion system thereby enhancing the efficiency and reducing specific fuel consumption of such system. Turning now to the drawings and referring first to FIG. 1 an aircraft 10 having a plurality of thrust generators such as represented by reference numeral 12 is illustrated. The aircraft 10 includes an aircraft frame 14 and a gas generator 16 coupled to the aircraft frame 14. In this exemplary embodiment, the gas generator 16 includes a jet engine that is configured to generate an exhaust gas. As illustrated, the aircraft 10 includes two jet engines 16 positioned on wings 18 of the aircraft. However, a greater or a lesser number of gas generators or jet engines 16 may be utilized for driving the aircraft 10 and generating the exhaust gas.

The thrust generators 12 are coupled to or integrated with the wings 18 and are configured to receive the exhaust gas from the gas generator 16 to generate thrust for driving the aircraft 10. In this exemplary embodiment, the aircraft 10 includes four thrust generators 12, two of the thrust generators 12 positioned on each of the wings 18. However a greater or a lesser number of the thrust generators may be employed. It should be noted that the plurality of thrust generators 12 for the aircraft 10 may have different sizes that receive exhaust gases through the single gas generator source 16. Further, in certain embodiments, the plurality of thrust generators 12 may be disposed on a fuselage of the aircraft 10. Each of the thrust generators 12 is configured to utilize the exhaust gas from the gas generator 16 to entrain incoming air to generate a high velocity flow using a Coanda profile that will be described in a greater detail below. As used herein, the term “Coanda profile” refers to a profile that is configured to facilitate attachment of a stream of fluid to a nearby surface and to remain attached even when the surface curves away from the original direction of fluid motion.

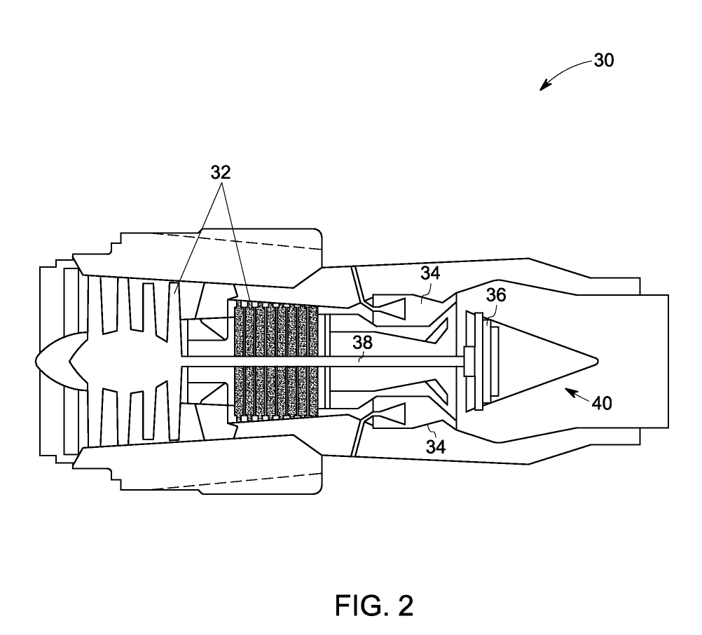

FIG. 2 is a diagrammatical illustration of an exemplary configuration 30 of the gas generator 16 of the aircraft 10 of FIG. 1. The gas turbine 30 includes a compressor 32 configured to compress ambient air. A combustor 34 is in flow communication with the compressor 32 and is configured to receive compressed air from the compressor 32 and to combust a fuel stream to generate a combustor exit gas stream. In addition, the gas turbine 32 includes a turbine 36 located downstream of the combustor 34. The turbine 36 is configured to expand the combustor exit gas stream to drive an external load. In the illustrated embodiment, the compressor 32 is driven by the power generated by the turbine 36 via a shaft 38. Further, in regular gas turbines such as turbo-fans, a high velocity jet of exhaust gases from the turbine 36 is expanded to atmospheric pressure through a propelling nozzle 40 that produces a net thrust that is opposite in direction to that of the jet.

In this exemplary embodiment, the fuel stream and air once combusted at a desired temperature and pressure in the combustor 34 generate exhaust gases. After power extraction to drive the compressor 32 of the gas generator 30, the generated exhaust gases are then directed towards the thrust generators 12 (see FIG. 1). The thrust generators 12 are configured to form a growing boundary layer and to entrain additional airflow. In this exemplary embodiment, a small portion of the fresh air entrained is rapidly mixed with the exhaust gas, at the wall, in a convergent area of the thrust generator 12 over a short distance by rapid entrainment and mixing with exhaust gas resulting in a growing, diluted exhaust gas/fresh air boundary layer of high energy. This is due to introduction of exhaust gas through several individual slots around the circumference that allows entrainment of fresh air in between. Moreover, another portion of the entrained air forms a shear layer with the mixed air and exhaust gas growing boundary layer to further accelerate the air at the converging section of the thrust generator 12 and to facilitate further mixing of the boundary layer and the incoming air to generate the high velocity airflow at a downstream section of the thrust generator 12. Furthermore, the downstream section of the thrust generator 12 generates the thrust from the difference in speed between the inlet entrained air and the high velocity mixed gases. In addition, the entrainment is amplified through the action of radial static pressure gradients generated by turning of the driving exhaust gases around the Coanda profile. In one exemplary embodiment, the downstream section includes a divergent section.

The air entrained in the core of the thrust generator 12 will thus be at lower velocities at a take off condition of the aircraft 10 but at much higher velocities in flight, making the entrainment and transfer of momentum from the driving exhaust gases very efficient and the difference between the aircraft velocity and emerging jet velocity relatively smaller. This translates into a higher propulsive efficiency for the thrust generator 12. The thrust generator 12 described above facilitates entrainment of air through the exhaust gases. In certain embodiments, a ratio of mass entrained by the thrust generator 12 and mass of the exhaust gases is between about 5 to about 15. The operation of the thrust generator 12 will be described in detail below.

In certain embodiments, a portion of the exhaust gas is expanded through the propelling nozzle 40 (see FIG. 2) to generate thrust and the remaining portion of the exhaust gases is directed to the thrust generators 12 to provide additional thrust. Alternately, the plurality of thrust generators 12 are configured to generate the overall thrust required for driving the aircraft 10 by means of the exhaust gases from the gas generator 30.

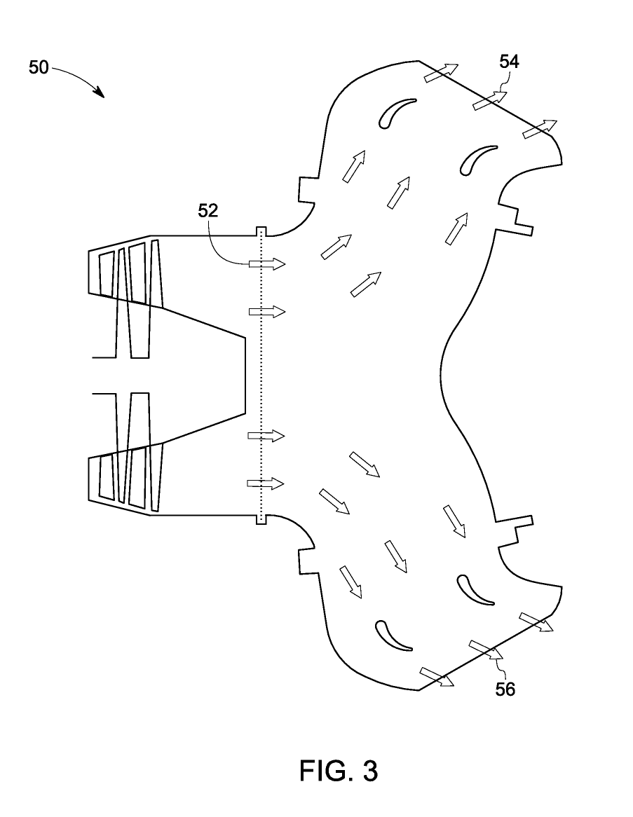

FIG. 3 is a diagrammatical illustration of exhaust gas flow split 50 from the gas generator 30 of FIG. 2 in accordance with aspects of the present technique. In this exemplary embodiment, exhaust gas flow 52 from the turbine 36 (see FIG. 2) is split into flows 56 and 58 that are directed to the plurality of thrust generators 12 (see FIG. 1). Further, the pressurized exhaust gas flows 56 and 58 are introduced over a Coanda profile to form the boundary layer and to entrain incoming air through the boundary layer to generate thrust.

By introducing the exhaust gas flows 56 and 58 over the Coanda profile via individual locations or through slots, a strong acceleration and change in direction of the flows 56 and 58 results, which facilitates entrainment of incoming air in between these individual jets. Further, the incoming air is accelerated and is expelled at an exit of the Coanda profile at pressures close to the ambient pressure. Beneficially, the entrainment of air, rapid transfer of energy and momentum through the thrust generator 12 and a low pressure drop across the thrust generator 12 results in enhanced thrust generation. In certain embodiments, the exhaust gas flow 52 from the gas generator 30 is choked having a temperature of about 1200° F. Therefore, the exhaust gas flow 56 or 58 at a periphery of the thrust generator 12 is sonic or supersonic at an inlet of the thrust generator 12 subsequently slowing down as it expands and mixes with ambient air.

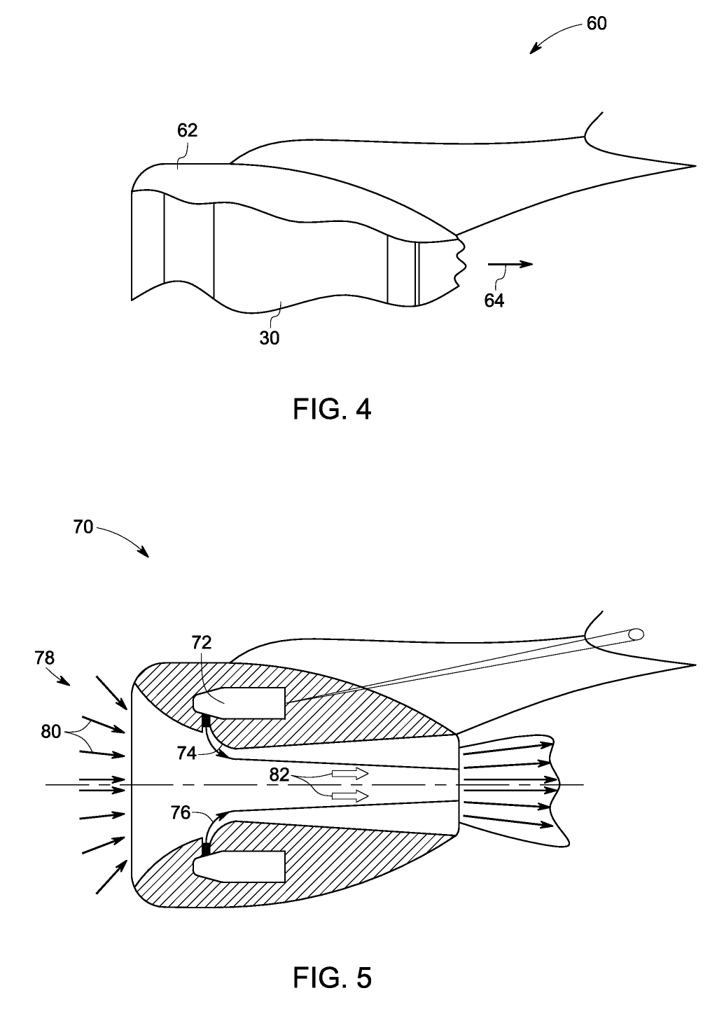

In certain embodiments, the exhaust gas flows 56 and 58 from the gas generator of FIG. 2 may be directed to a plenum for introducing the exhaust gas flows 56 and 58 within the thrust generators 12. FIG. 4 is a diagrammatical illustration of an attachment mechanism 60 of the gas generator 30 of FIG. 2 with the aircraft 10 of FIG. 1 in accordance with aspects of the present technique. As illustrated, the gas generator 30 is coupled to or integrated with each of the wings 18 (see FIG. 1) through a wing strut 62. The gas generator 30 is configured to generate the exhaust gas 52 that is directed to a plenum as indicated by reference numeral 64. Further, the plenum is configured to direct the exhaust gas 52 radially into the thrust generator 12 and along the Coanda profile, as described below with reference to FIGS. 5-9.

FIG. 5 is a diagrammatical illustration of an exemplary configuration 70 of the thrust generator 12 of the aircraft 10 of FIG. 1 in accordance with aspects of the present technique. As illustrated, the thrust generator 70 includes a plenum 72 that is configured to receive exhaust gas 64 (see FIG. 4) from the gas generator 30 (see FIG. 4) and to provide the exhaust gas over a Coanda profile 74 that is configured to facilitate attachment of the exhaust gas 64 to the profile 74. In certain embodiments, introduction of heat using a fuel into the plenum 72 will increase the energy and result in the exhaust gas 64 entraining more air or accelerating the air to higher velocities. In this exemplary embodiment, the plenum 72 is annular around a cowl of the thrust generator 70. In certain embodiments, the plenum 72 may be compartmented into a plurality of plenums that supply segments of exhaust gas slots. In one exemplary embodiment, the Coanda profile 74 includes a logarithmic profile. In operation, a pressurized flow of the exhaust gas 64 from the plenum 72 is introduced along the Coanda profile 74 as represented by reference numeral 76. Further, the thrust generator 70 includes an air inlet 78 for introducing airflow 80 within the thrust generator 70.

During operation, the pressurized exhaust gas 76 entrains airflow 80 to generate a high velocity airflow 82. In particular, the Coanda profile 74 facilitates relatively fast mixing of the pressurized exhaust gas 76 with the entrained airflow 80 and generates the high velocity airflow 82 by transferring the energy and momentum from the pressurized exhaust gas 76 to the airflow 80. In this exemplary embodiment, the Coanda profile 74 facilitates attachment of the pressurized exhaust gas 76 to the profile 74 until a point where the velocity of the flow drops to a fraction of the initial velocity while imparting momentum and energy to the airflow 80. It should be noted that the design of the thrust generator 70 is selected such that it enhances the acceleration of incoming airflow 80 that flows from an ambient condition to the outlet of the thrust generator 70 thereby maximizing the thrust generated from the thrust generator 70. Further, the high velocity airflow 80 may be utilized to generate thrust for driving the aircraft 10.

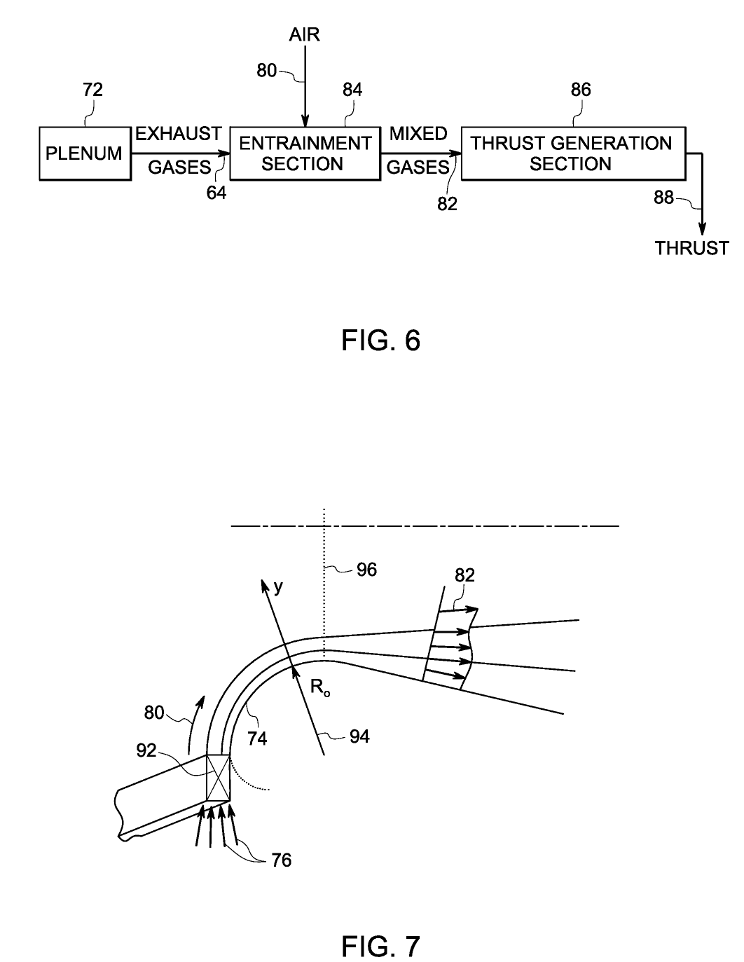

FIG. 6 is a block diagram illustrating the operation of the thrust generator 70 of FIG. 5. As illustrated, the plenum 72 is configured to receive the exhaust gas 64 from the gas generator 30. The exhaust gas 64 from the plenum 72 is introduced into an entrainment section 84 of the thrust generator 70. As described above, the entrainment section 84 includes the Coanda profile 74 for entraining air 80 to generate mixed gases (air and exhaust gases) 82 at high ratios and high velocities. Such high velocity flow 82 is then directed to a thrust generation section 86 of the thrust generator 70 for creating thrust 88 from the high velocity flow 82.

Advantageously, using the thrust generator 70, the entrainment rate of air 80 may be increased beyond current capabilities of fans and without the use of fans and other moving parts in the aircraft 10 (see FIG. 1), for which scale-up is very difficult and resulting in high complexity and mass. It should be noted that the thrust 88 generated from the thrust generator 70 depends on the mass and energy of jet 82. In the illustrated embodiment the high entrainment rate and the rapid momentum transfer through the thrust generator 70 facilitates generation of desired thrust 88 from the high velocity jet 82. Moreover, the thrust generator 70 described above does not have a high drag core associated, so that the incoming volume of fresh air 80 that is moving towards the core of the thruster 70 is going through at the aircraft velocity and is only slightly accelerated. The high entrainment rate along with the value of velocity leaving the thrust generator 70 is very close to that of the aircraft 10 results in very high propulsive efficiency. Beneficially, the thrust 88 is maintained high through the thrust generator 70 but the thruster exit velocity is used to achieve the thrust lower than in comparable turbofan engines, resulting in higher propulsive efficiency. Also, in parallel, the effective bypass ratio of the proposed gas generator and thruster arrangements is higher than that achievable using conventional turbofan technology.

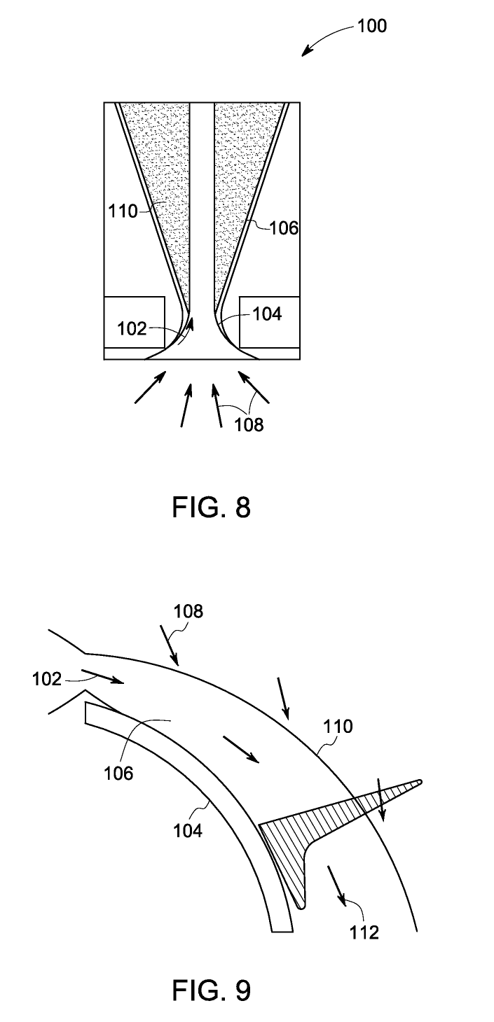

FIG. 7 is a diagrammatical illustration of a Coanda profile surface of the thrust generator 70 of FIG. 5 in accordance with aspects of the present technique. As illustrated, the exhaust gases 76 from the plenum 72 are directed into the thrust generator 70 and along the Coanda profile 74. In an exemplary embodiment, a pressure augmentor (not shown) is coupled to the plenum 72 and is configured to increase a pressure of the exhaust gases 76 in the plenum 72. In one embodiment, the pressure augmentor includes a pump. In certain embodiments, the thrust generator 70 may be operated at a choked condition to enhance the efficiency of the thrust generator 70. Further, in certain operating conditions of the aircraft 10, such as during a take-off condition, the thrust generator 70 is configured to enhance the thrust by increasing the pressure of the exhaust gases in the plenum 72 from either the gas generator 30 or by using the pressure augmentor in the plenum 72. The Coanda profile 74 facilitates attachment of the exhaust gases 76 to the profile to form a boundary layer by introduction at several circumferential locations and entrains in between these locations incoming airflow 80 to generate the high velocity airflow 82. In particular, the air supplied 80 through the air inlet 78 (see FIG. 5) forms a shear layer with the boundary layer to accelerate the airflow 80 at a converging section of the thrust generator 70 and to facilitate mixing of the boundary layer and the incoming airflow 80 to generate the high velocity airflow 82 at an exit section of the thrust generator 70. The formation of the boundary and shear layers for generating the high velocity airflow 82 will be described in detail below with reference to FIGS. 8-9.

The exhaust gases 76 are directed radially into the axis of the thrust generator 70 via a plurality of individually distributed slots 92 and along the Coanda profile 74 that uses a curvature 94 for maximizing entrainment via the combination of shear and radial pressure gradient while ensuring that the boundary layer remains attached to the wall of the thrust generator. As a result, at a throat area 96 of the Coanda profile 84, the flow is still attached and the boundary layer has a relatively high momentum with a maximum velocity of about 0.8 times the initial injection velocity. It should be noted that the reduction in the initial velocity of the exhaust gases 76 is due to entrainment of slower airflow 80 and transfer of momentum and energy to entrained airflow 80, as well as due to some friction losses at the walls. Furthermore, the high velocity exhaust gas 76 from the plenum 72 generates a low pressure zone due the curvature of the driving flow along the Coanda profile that aids in the entrainment of air.

FIG. 8 is a diagrammatical illustration of flow profiles 100 of air and exhaust gases within the thrust generator 70 of FIG. 5 in accordance with aspects of the present technique. As illustrated, exhaust gases 102 are directed inside the thrust generator 70 (see FIG. 5) and over a Coanda profile 104. In the illustrated embodiment, the exhaust gases 102 are introduced into the thrust generator 70 at a substantially high velocity and pressure through individual slots 92 (see FIG. 7). In operation, the Coanda profile 104 facilitates attachment of the exhaust gases 102 with the profile 104 to form a boundary layer 106 that entrains, grows and facilitates mixing of exhaust gases 102 and portion of air 108. In this embodiment, the geometry and the dimensions of the profile 104 are optimized to achieve a desired thrust. Further, part of the flow of incoming air 108 is entrained by the growing, mixed boundary layer 106 to form a shear layer 110 with the boundary layer 106. It should be noted that the entrainment of ambient air 108 is amplified by a radial static pressure gradient obtained by the curvature of the stream lines around the Coanda profile 104. Further, the radial pressure gradient imposed on the flow works with the shear at the boundary layer 106 to increase the entrainment. Thus, the shear layer 110 formed by the growth and mixing of the high energy boundary layer 106 with the entrained airflow 108 facilitates formation of a rapid and uniform mixture within the thrust generator 70. The attachment of exhaust gases 102 to the Coanda profile 104 due to the Coanda effect in the thrust generator 70 will be described in detail below with reference to FIG. 9.

FIG. 9 is a diagrammatical illustration of the formation of boundary layer 106 adjacent the profile 104 in the thrust generator 70 of FIG. 5 based upon the Coanda effect. In the illustrated embodiment, the exhaust gases 102 attach to the profile 104 and remain attached even when the surface of the profile 104 curves away from the initial fuel flow direction. More specifically, as the exhaust gases 102 decelerate there is a pressure difference across the flow, which deflects the exhaust gases 102 closer to the surface of the profile 104. As will be appreciated by one skilled in the art as the exhaust gases 102 move across the profile 104, a certain amount of skin friction occurs between the exhaust gases 102 and the profile 104. This resistance to the flow 102 deflects the exhaust gases 102 towards the profile 104 thereby causing it to stick to the profile 104. Further, the boundary layer 106 formed by this mechanism entrains incoming airflow 108 to form a shear layer 110 with the boundary layer 106 to promote entrainment and mixing of the airflow 108 and exhaust gases 102. Furthermore, the shear layer 110 formed by the detachment and mixing of the boundary layer 106 with the entrained air 108 generates a high velocity airflow 112 that is utilized for enhancing efficiency of a propulsion system by generating thrust. It should be noted that as the aircraft 10 (see FIG. 1) is taking off, the flow 108 has reduced velocity and the entrainment rate is high. Further, as the aircraft 10 is in flight, the velocity of airflow 108 becomes higher and the entrainment also remains high. Thus momentum and energy transfer from the exhaust gas 102 is facilitated by the incoming airflow 108 and higher propulsive efficiency results due to lower difference between the velocity of jet leaving the thrust generator 70 and aircraft's speed.

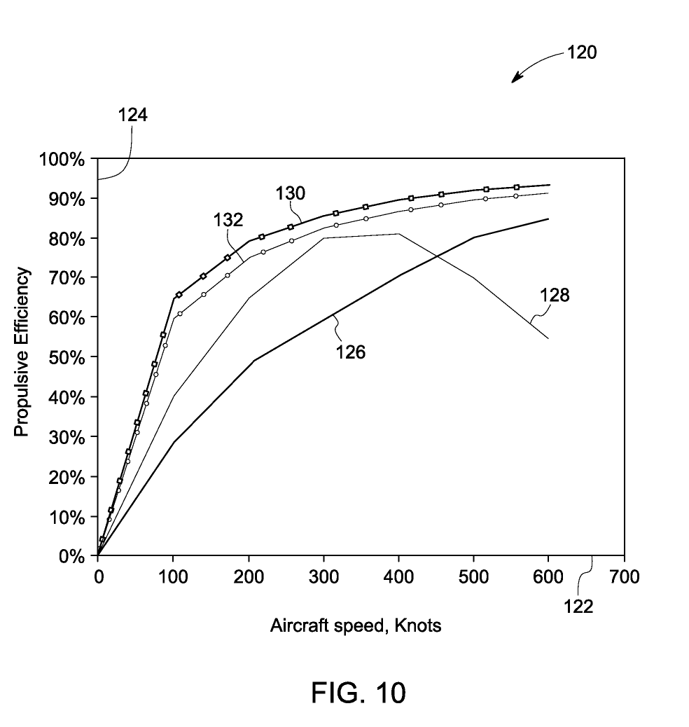

FIG. 10 is a graphical representation of exemplary analysis results 120 for propulsion efficiency of existing propulsion systems and a propulsion system having the thrust generator 70 of FIG. 5 in accordance with aspects of the present technique. The abscissa axis 122 represents an aircraft speed measured in Knots and the ordinate axis 124 represents the propulsion efficiency. In this embodiment, profiles 126 and 128 represent propulsion efficiencies of existing turbofan and turbo-prop based propulsion systems. Further, profiles 130 and 132 represent propulsion efficiencies of propulsion systems having the thrust generators 70 at pressure ratios of about 20 psig and 35 psig respectively. As can be seen, the propulsion efficiencies of propulsion systems having the thrust generators 70 are substantially higher than the propulsion efficiencies of existing turbofan and turbo-prop based propulsion systems. Further, the propulsion efficiency of the propulsion system having the thrust generator 70 at a pressure ratio of 20 psig is relatively higher than that of the propulsion system having the thrust generator 70 at a pressure ratio of 35 psig. As will be appreciated by one skilled in the art, a plurality of parameters such as the Coanda profile geometry, pressure ratios, pressure of the exhaust gas and so forth may be adjusted to achieve a desired propulsion efficiency. Further, the selected parameters would also determine an architecture and layout of the gas generator that may be configured as a turbofan engine with a low bypass ratio and high pressure ratio to allow the exhaust gas flow pressure parameter to be freed up from its gas turbine core cycle exit conditions.

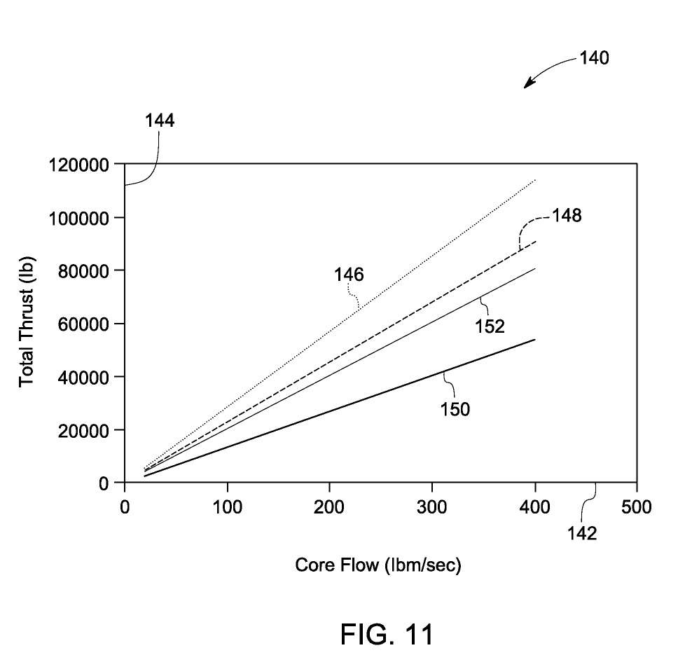

FIG. 11 is a graphical representation of exemplary analysis results 140 for thrust generated from existing turbofan based propulsion systems and a propulsion system having the thrust generator 70 of FIG. 5 in accordance with aspects of the present technique. The abscissa axis 142 represents flow rate (lbm/sec) and the ordinate axis 144 represents the total thrust (lbs). In this embodiment, profiles 146 and 148 represent thrusts of existing turbofan based propulsion systems with by-pass ratios of about 9 with a fan pressure ratio of 1.5 and a bypass ratio of about 5 with a fan pressure ratio of 1.8 respectively. Further, profiles 150 and 152 represent generated thrust of propulsion systems having the thrust generators 70 at entrainment rates of about 6 and 9 respectively. As can be seen, the propulsion systems having the thrust generators are able to generate thrusts to propel the propulsion system and based on the design and number of thrust generators, the generated thrust may be comparable to existing turbofan based propulsion systems. Again, a plurality of parameters such as air entrainment rate may be optimized to achieve the desired efficiency of such systems.

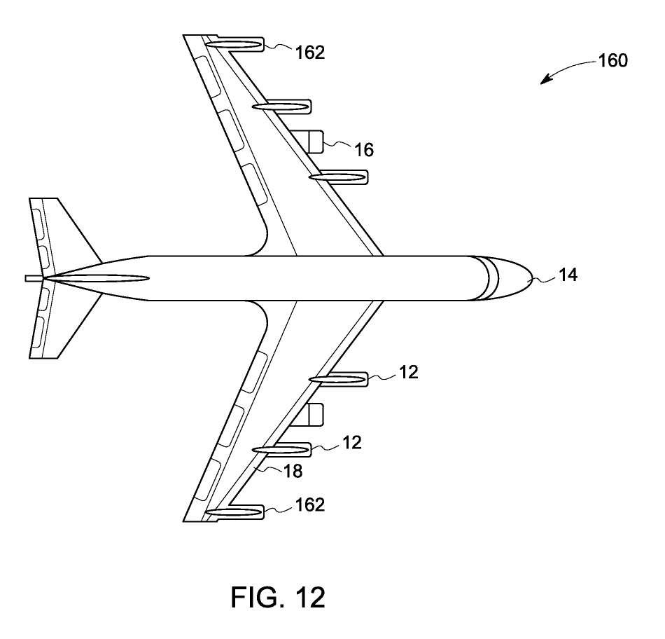

The thrust generator 70 described above utilizes the combination of a working fluid and ambient air to generate thrust for driving the propulsion system thereby enhancing the efficiency and specific fuel consumption of such system. In certain embodiments, the thrust generator 70 facilitates the Short Take-Off and Landing (STOL) and Vertical Take-Off and Landing (VTOL) of the aircraft 10 (see FIG. 1). FIG. 12 illustrates an exemplary aircraft 160 having thrust generators 162 positioned at ends of the wings 18 of the aircraft 160. In this exemplary embodiment, the high velocity jet 82 emerging from the thrust generators 162 facilitates the aircraft 160 to lift vertically during a VTOL operating condition. In certain embodiments, the thrust generators 162 can change their orientation in flight via controls to shorten take off or landing distances by rotation of the thrust generators 162. Advantageously since the thrust generator 162 has multiple degrees of freedom, the thrust generator 162 may be employed to adjust an attitude of the aircraft 10 in flight or during hovering of the aircraft 10.

The various aspects of the method described hereinabove have utility in enhancing efficiency of different propulsion systems such as aircrafts, under water propulsion systems and rocket and missiles. The technique described above employs a thrust generator that can be integrated with existing propulsion systems and utilizes a driving fluid such as exhaust gases from a gas generator to entrain a secondary fluid flow for generating a high velocity airflow. In particular, the thrust generator employs the Coanda effect to generate the high velocity airflow that may be further used for generating thrust thereby enhancing the efficiency of such systems. Advantageously, the thrust generation using such thrust generators eliminates the need of moving parts such as fans in existing turbofan based propulsion systems thereby substantially reducing cost of operation of such systems. Further, the thrust generators facilitate operation with choking condition at more than one location thereby enhancing the efficiency of such systems particularly at operating conditions such as Short Take-Off and Landing (STOL) and Vertical Take-Off and Landing (VTOL).

While only certain features of the invention have been illustrated and described herein, many modifications and changes will occur to those skilled in the art. It is, therefore, to be understood that the appended claims are intended to cover all such modifications and changes as fall within the true spirit of the invention.

1. A thrust generator, comprising:
an air inlet configured to introduce air within the thrust generator;
a plenum configured to receive exhaust gas from a gas generator and to provide the exhaust gas over a Coanda profile, wherein the Coanda profile is configured to facilitate attachment of the exhaust gas to the profile to form a boundary layer and to entrain incoming air from the air inlet to generate thrust.

2. The thrust generator of claim 1, wherein the gas generator comprises an aircraft engine and the generated thrust is utilized for driving an aircraft.

3. The thrust generator of claim 2, wherein the thrust generator is operated at a choked condition for enhancing an efficiency of the thrust generator.

4. The thrust generator of claim 2, further comprising a pressure augmentor configured to increase a pressure of the exhaust gas in the plenum.

5. The thrust generator of claim 1, wherein the Coanda profile comprises a logarithmic profile.

6. The thrust generator of claim 1, wherein a quantity of incoming air is increased by entrainment through the air inlet and is rapidly mixed with the boundary layer to increase a boundary layer thickness at a converging section of the thrust generator while facilitating momentum and energy transfer of the boundary layer via shear layers and a radial pressure gradient to the incoming air to generate a high velocity airflow at a downstream section of the thrust generator.

7. The thrust generator of claim 6, wherein the downstream section of the thrust generator generates the thrust from a difference in momentum between inlet and exhaust fluxes of airflow.

8. The thrust generator of claim 1, wherein the plenum is configured to direct the exhaust gas radially into the thrust generator and along the Coanda profile.

9. An aircraft, comprising:
an aircraft frame;
a gas generator coupled to the aircraft frame and configured to generate exhaust gas; and
a plurality of thrust generators coupled to the aircraft frame and configured to receive the exhaust gas from the gas generator and to generate thrust for driving the aircraft, wherein each of the plurality of thrust generator comprises at least one surface of the thrust generator having a Coanda profile configured to facilitate attachment of the exhaust gas to the profile to form a boundary layer and to entrain incoming air from an air inlet to generate high flow rate and velocity airflow.

10. The aircraft of claim 9, wherein the gas generator comprises:
a compressor configured to compress ambient air;
a combustor in flow communication with the compressor, the combustor being configured to receive compressed air from the compressor assembly and to combust a fuel stream to generate an exhaust gas;
a turbine located downstream of the combustor and configured to expand the exhaust gas.

11. The aircraft of claim 9, further comprising a plenum configured to receive the exhaust gas from the gas generator and to direct the exhaust gas radially into the thrust generator and along the Coanda profile.

12. The aircraft of claim 11, further comprising a pressure augmentor configured to increase a pressure of the exhaust gas in the plenum.

13. The aircraft of claim 9, wherein the thrust generator is operated at a choked condition for enhancing an efficiency of the thrust generator.

14. The aircraft of claim 9, wherein the Coanda profile comprises a logarithmic profile.

15. The aircraft of claim 9, wherein the air supplied through the air inlet forms a shear layer with the growing and mixing boundary layer to accelerate the air at a converging section of the thrust generator and to facilitate mixing and growth via entrainment of the boundary layer and the incoming air to generate a high velocity airflow at a downstream section of the thrust generator.

16. The aircraft of claim 15, wherein the downstream section of the thrust generator generates the thrust from a difference in momentum between inlet and exhaust fluxes of airflow.

17. The aircraft of claim 9, wherein an orientation of the thrust generators may be changed by rotation around axes to facilitate aircraft attitude changes.

18. The aircraft of claim 17, wherein the thrust generators are configured to adjust the attitude of the aircraft during Short Take-Off and Landing (STOL), Vertical Take-Off and Landing (VTOL) and hovering of the aircraft.

19. A method for generating thrust, comprising:
introducing exhaust gas from a gas generator over a Coanda profile of a thrust generator to form a boundary layer; and
entraining air through the boundary layer to generate thrust from a difference in momentum between inlet and exhaust fluxes of airflow.

20. The method of claim 19, wherein the introducing step comprises receiving the exhaust gas from an aircraft engine.

21. The method of claim 19, further comprising forming a shear layer of the entrained air with the boundary layer to accelerate the air at a converging section of the thrust generator and to facilitate mixing and growth of the boundary layer via entrainment of the boundary layer and the incoming air to generate a high velocity airflow at a downstream section of the thrust generator.

22. A method of enhancing a propulsion efficiency of an aircraft, comprising:
coupling at least one thrust generator to a gas generator of the aircraft, wherein the at least one thrust generator is configured to generate thrust by diverting exhaust gas from the gas generator over a Coanda profile to form a boundary layer and subsequently entrain incoming air through the boundary layer.

23. The method of claim 22, further comprising operating the at least one thrust generator at a choked condition for enhancing the efficiency of the thrust generator.

24. The method of claim 22, further comprising increasing a pressure of the exhaust gas through the gas generator, or by using a pressure augmentor.

25. The method of claim 22, further comprising increasing the energy of the exhaust gas energy via addition of heat, or fuel to a thrust generator plenum prior to introduction over the Coanda profile.
